(19) United States
(12) Patent Application Publication
(10) Pub. No.: US 2003/0110105 A1
(43) Pub. Date: Jun. 12, 2003

(54) Expendable supplies, package for packaging expendable supplies, collective package, system for managing expendable supplies, and method for managing expendable supplies

(75) Inventors: Toshiyasu Minami, Nagano-ken (JP); Hiroto Nakamura, Nagano-ken (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/289,452

(22) Filed: Nov. 7, 2002

(30) Foreign Application Priority Data
Nov. 12, 2001 (JP) P2001-346624

(51) Int. Cl. G06F 17/60

(52) U.S. Cl. 705/28

(57) ABSTRACT

Expendable supplies which are collectable and recyclable are respectively accommodated in packages at shipping. One of different identifiers is given to each expendable supply. The identifier of each expendable supply is the same as an identifier given to the package that packages the expendable supply.

### BACKGROUND OF THE INVENTION

The present invention relates to expendable supplies, package for packaging the expendable supplies, collective package, a system for managing expendable supplies, and a method for managing expendable supplies.

Presently, for effective utilization of resources, expendable supplies such as ink cartridges or toner cartridges are collected for reuse after ink or toner is used. For promoting the reuse of the expendable supplies and collecting a large amount of used expendable supplies, some manufacturing companies have a special contract with a sales agent that collects a large amount of expendable supplies and has a high collecting rate. Such special contracts include reduction in prices of expendable supplies.

However, although the sales agent has a contract with the manufacturing company on condition of a predetermined collecting rate, it is not clear whether the sales agent achieves the collecting rate or not. Conventionally, data of the number of collected expendable supplies and the collection date has been manually input to a managing computer based on the sales slips to check the collecting rate of the sales agent. That is, it is necessary to manually input data based on the sales slips of the sales agent for checking the collecting rate. Therefore, it takes labor and time.

### SUMMARY OF THE INVENTION

An object of the present invention is to provide expendable supplies, package, collective package, a system for managing expendable supplies and a method for managing expendable supplies that enable users to easily gather collection information such as a collecting rate and a collection date without taking labor and time.

For achieving the above objective, according to a first aspect of the present invention, expendable supplies that are collectable and recyclable are provided. One of different identifiers is given to each expendable supply. The identifier of each expendable supply is the same as an identifier given to a package that packages the expendable supply at shipping.

According to a second aspect of the present invention, packages are provided. The packages are used for packaging expendable supplies at shipping. The expendable supplies are collectable and recyclable. One of different identifiers is given to each expendable supply. An identifier is given to each package, and the identifier of each package is the same as the identifier given to the corresponding expendable supply.

According to a third aspect of the present invention, a collective package is provided. This package collectively packages a plurality of expendable supplies that are collectable and recyclable. One of different identifiers is given to each expendable supply. The identifier of each expendable supply is the same as an identifier given to a package that packages the expendable supply at shipping. The collective package has a collective identifier including the information of the identifiers of the expendable supplies.

According to a fourth aspect of the present invention, a system for managing expendable supplies is provided. In the system, one of different identifiers is given to each expendable supply. The identifier of each expendable supply is the same as an identifier given to a package that packages the expendable supply at shipping. The system ships the expendable supplies and collects the supplies after the supplies are used. The system comprises first recording means for recording shipment information of each expendable supply in association with the identifier of the corresponding package, wherein the identifiers of the packages are read at shipping, second recording means recording collection time information of each expendable supply in association with the identifier of the supply, wherein the identifiers of the expendable supplies are read when the supplies are collected; and collection information generating means, which computes collection information including a collection rate and a collection period based on the shipment information and the collection time information respectively recorded by the first recording means and the second recording means.

According to a fifth aspect of the present invention, a system for managing expendable supplies is provided. The system comprises first reading means for reading identifiers given to packages of the expendable supplies at shipping, first recording means for recording shipment information in association with the identifiers read by the shipment time identifier reading means, second reading means for reading the identifiers given to the collected expendable supplies or the identifiers given to the collected packages, second recording means for recording collection time information based on the identifiers read by the collection time identifier reading means and generating means for computing collection information including a collection rate and a collection period based on the shipment information and the collection time information.

According to a sixth aspect of the present invention, a method for managing expendable supplies is provided. The method comprises steps of reading the identifiers of the packages, recording shipment information in association with the read identifiers, reading the identifiers of the collected expendable supplies, recording collection time information in association with the identifiers and obtaining collection information including a collection rate and a collection period based on the shipment information and the collection time information.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a diagrammatic view of a system for managing expendable supplies according to an embodiment;

FIG. 2 is a perspective view of an outward appearance of expendable supplies and package for accommodating the expendable supplies when shipping according to a first embodiment;

FIG. 3 is a chart of data stored in a shipping data storing section according to the first embodiment;

FIG. 4 is a flowchart showing steps of a shipping process according to the embodiment;

FIG. 5 is a flowchart showing steps of a collecting process according to the embodiment;

FIG. 6 is a perspective view of an outward appearance of collective package according to a second embodiment;

FIG. 7 is a chart of data stored in a shipping data storing section according to the second embodiment; and

FIG. 8 is a perspective view of an outward appearance of collective package according to a third embodiment.

### DETAILED DESCRIPTION OF THE PREFERRED EMBODIMENTS

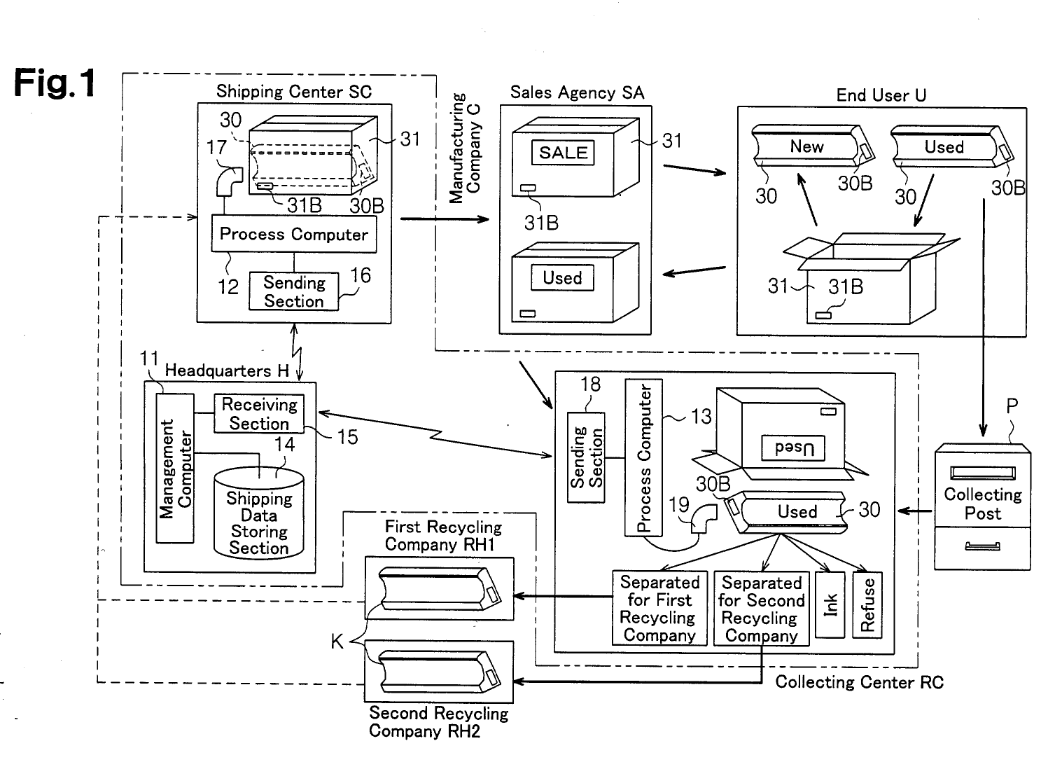

Hereinafter, a system for managing expendable supplies according to a first embodiment of the present invention will be described with reference to FIGS. 1-5.

A manufacturing company C has a headquarters H, a shipping center SC, and a collecting center RC. A management computer 11, a process computer 12, and a process computer 13 are arranged in the headquarters H, the shipping center SC and the collecting center RC, respectively. Each computer 11, 12, 13 has input means (not shown) such as a keyboard or a mouse and display means (not shown) such as a monitor.

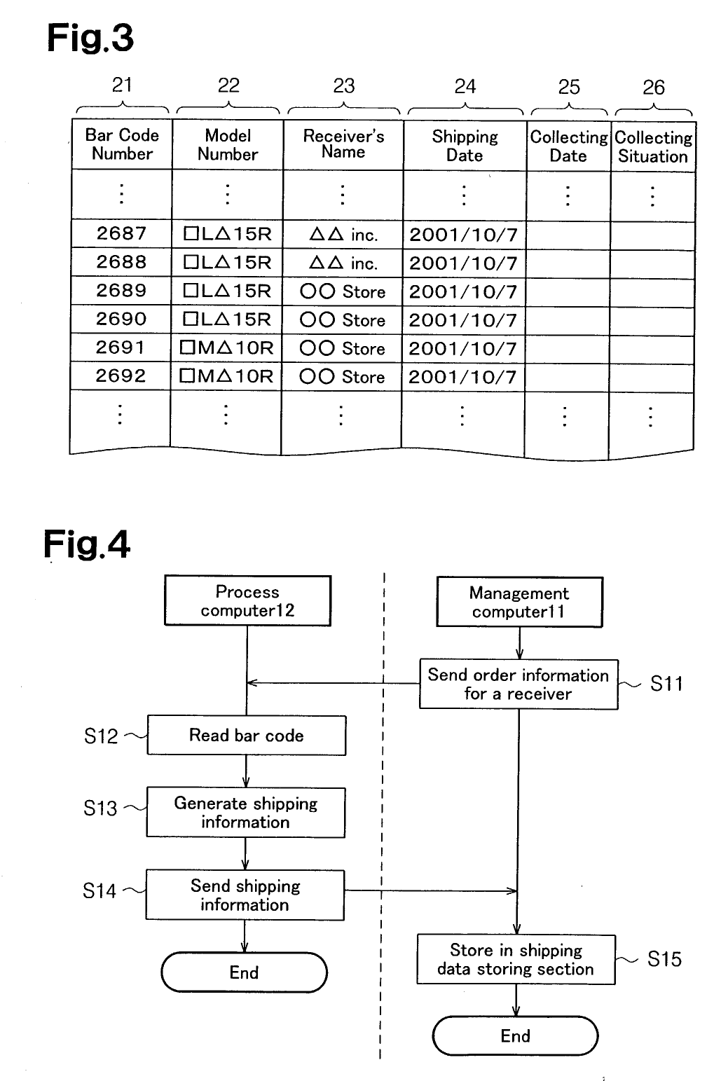

The management computer 11 at the headquarters H functions as first recording means, second recording means and collection information generating means. The management computer 11 has a shipping data storing section 14 and stores shipping information in the shipping data storing section 14 and reads the shipping information from the shipping data storing section 14 and generates collection information such as a collecting rate. The shipping information such as a bar code number 21 as identifier, a model number 22, a name of a receiver 23 and a shipping date 24 is stored in the shipping data storing section 14, as shown in FIG. 3. The collection information such as a collection date 25 and collection situation 26 is also stored in the shipping data storing section 14. A receiving section 15 is arranged in the management computer 11. The receiving section 15 receives data from the process computer 12 at the shipping center SC and receives data from the process computer 13 at the collecting center RC.

The process computer 12 at the shipping center SC of the manufacturing company C has a sending section 16. The process computer 12 sends data to the receiving section of the management computer 11 via the sending section 16. A bar code reading terminal 17 as identifier reading means at shipping is connected to the process computer 12. The bar code reading terminal 17 reads the bar code number 21 of a bar code 31B at shipping.

On the other hand, the process computer 13 at the collecting center RC of the manufacturing company has a sending section 18 and sends data to the receiving section 15 of the management computer 11 via the sending section 18. A bar code reading terminal 19 as identifier reading means at collecting is connected to the process computer 13. The bar code reading terminal 19 reads the bar code number 21 of the bar code 30B at collecting.

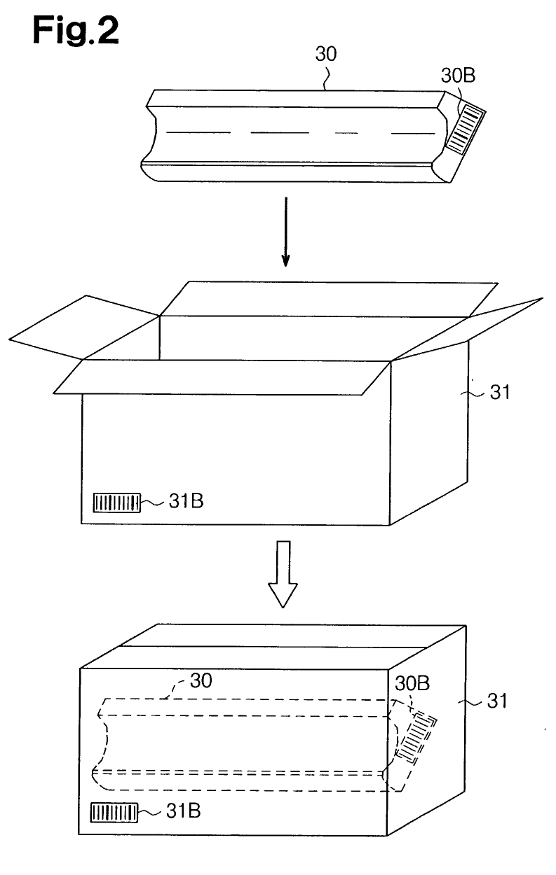

As shown in FIG. 2, one-dimensional bar code 30B is put on a side wall of a toner cartridge 30. The toner cartridge 30 is an expendable item that is shipped from the shipping center SC. The bar code 30B has a bar code number 21 that is different for each expendable supplies. The bar cod number 21 may be a serial number or may be the same as a number of a toner cartridge 30 that has been collected and is not on the market.

On the other hand, a box 31 is a package for accommodating a toner cartridge 30 at shipping and the bar code 31B the same as the bar code 30B is put on the box 31. The bar code 31B has the same bar code number as the bar code 30B of the toner cartridge that is accommodated in the box 31.

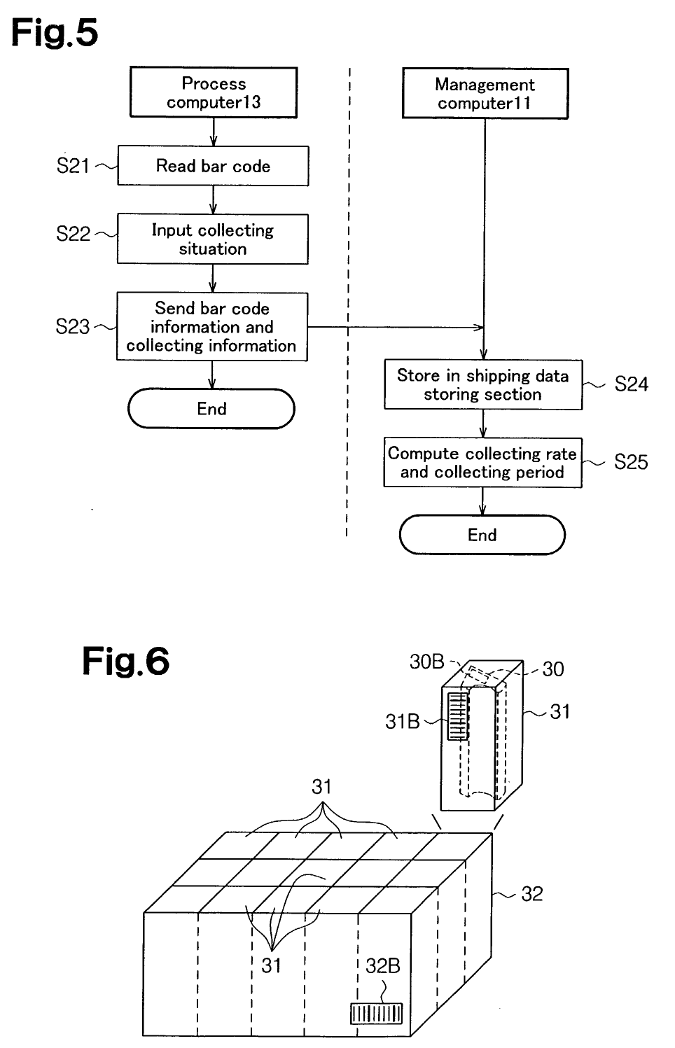

Next, an operation of the system for managing expendable supplies according to the embodiment will be explained with reference to FIGS. 4 and 5.

The bar codes 30B and 31B are put on the toner cartridge 30 that is manufactured as expendable supplies and on the box 31 for accommodating the toner cartridge 30, respectively, as shown in FIG. 2. The toner cartridge 30 is accommodated in the box 31 where the bar code 31B having the same number as the bar code number 21 of the bar code 30B is put.

The shipping process shown in FIG. 4 is executed at shipping. The management computer 11 at the manufacturing company C sends order information for the receiver to the process computer 12 of the shipping center SC (step S11). The order information for the receiver includes, for example, the name of the receiver 23, a model name that is sent and the number of toner cartridges. The receiver is the sales agency SA to which the toner cartridge 30 is sent. The process computer 12 sends a predetermined number of cartridges 30 to the sales agency SA having the receiver's name 23 based on the received information. The process computer 12 at the shipping center SC reads the bar code number 21 of the bar code 31B on the box 31 via the bar code reading terminal 17 at shipping (step S12). The process computer 12 generates shipping information according to the read bar code number 21, the applied model number 22, the receiver's name 23 and the shipping date 24 (the date when the bar code number 21 is read by the bar code reading terminal 17) (step S14). The generated shipping information is temporally stored in the process computer 12. The process computer 12 sends the generated shipping information to the management computer 11 at the manufacturing company C (step S14). If the receiving section 15 of the management computer 11 receives the shipping information from the shipping center SC, the received shipping information is stored in the shipping data storing section 14 as shown in FIG. 3 (step S15).

After the shipping process, the toner cartridge 30 is shipped to each sales agency SA and sold to an end user U at each sales agency SA. The end user U takes out the toner cartridge 30 from the box 31 to use it.

The used toner cartridge 30 that has been used is accommodated in the box 31 instead of the toner cartridge that is taken out of the box 31 and collected by the sales agency SA. In this case, the bar code number 21 of the bar code 31B that is put on the box 31 is different from the bar code number 21 of the accommodated toner cartridge 30. The used toner cartridge 30 may be accommodated in a collecting post P arranged at a predetermined place and collected not via the sales agency SA. The used toner cartridges 30 that are collected by the sales agency SA and the collecting post are collected to the collecting center RC.

The bar code reading terminal 17 reads the bar code number 21 of the bar code 30B on the used toner cartridge 30 that is collected at the collecting center RC, as shown in FIG. 5 (step S21). The read bar code number 21 of the bar code 30B and the collection date 25 that is a date when the data is read are temporally stored in the process computer 13. At this time, the collection situation 26 is input by input means (not shown) if there is a special matter with respect to the collected toner cartridge 30, for example, if a large amount of ink is solidified and remains (step S22). Next, the process computer 13 sends the bar code number 21 of the bar code 30B and the collection time information including the collection date 25 and the collection situation 26 to the management computer 11 (step S23).

The management computer 11 stores the collection time information related to the bar code number 21 including the collection date 25 and the collection situation 26 in the shipping data storing section 14 based on the bar code number 21 of the bar code 30B received from the process computer 13 at the collecting center RC. The collection time information including the collection date 25 and the collection situation 26 is stored in the shipping data storing section 14 with relating to the bar code number 21 (step S24).

The management computer 11 computes the collection rate and the collection period based on the shipping information stored in the shipping data storing section 14 (step S25). The management computer 11 computes the collection rate data for each sales agency or each model from the data of the receiver's name 23, the shipping date 24 and the collection date 25 and computes the collection period of the toner cartridge 30 from the data of the shipping date 24 and the collection date 25.

Afterwards, the toner cartridge 30 whose bar code 30B is read is separated into remaining ink, refuse, products manufactured by other company and a case K of the toner cartridge 30. The remaining ink is sent to an ink process dealer and the refuse is sent to a recycling dealer. The case K of the toner cartridge 30 is sent to a plurality of recycling companies RH1, RH2. The toner cartridge 30 that is recycled at a plurality of recycling companies RH1, RH2 is sent to the shipping center again. The above-described shipping process is executed at the shipping center SC. In this case, the bar code number 21 that is put on the recycled toner cartridge 30 and the box 31 may be same number as the collected toner cartridge 30 or a new number may be applied to the recycled toner cartridge 30.

The following advantages are obtained in the system for managing expendable supplies according to the above embodiment.

(1) In the embodiment, the bar code 30B having a bar code number 21 that is different for each toner cartridge 30 is put on the toner cartridge 30. The bar code 31 having the same number as the bar code number 21 put on the toner cartridge 30 is put on the box 31 that accommodates the toner cartridge 30. Therefore, by reading the bar code 31B of the box 31, the bar code number 21 of each toner cartridge 30 is easily read at shipping in a condition that the toner cartridge 30 is accommodated in the box 31. The shipping information including the model number 22, the receiver's name 23 and the shipping date 24 can be stored in the shipping data storing section 14 easily with relating to the bar code number 21.

(2) In the embodiment, when the toner cartridge 30 is collected, the bar code 30B is read by the bar code reading terminal 19. The collection time information including the collection date 25 and the collection situation 26 is stored in the shipping data storing section 14 with relating to the bar code number 21 of the bar code 30B. Therefore, the management computer 11 easily computes the collection information such as the collection rate and the collection period from the information stored in the shipping data storing section 14 without taking labor and time.

(3) In the embodiment, the bar code number 21 is used as the identifier related to the shipping information of each toner cartridge 30. Therefore, even if another dealer reads the bar code to know the bar code number, the dealer cannot know the sales customer information or the shipping information such as the shipping date that is related to the bar code as shown in FIG. 3. Since the shipping information (the model number 22, the receiver's name 23, the shipping date 24 ad the collection date 25) that is stored in the shipping data storing section 14 at shipping and the collection time information (the collection date 25 and the collection situation 26) can be read based on the bar code number 21, the information can be managed without leaking. Therefore, reading of the bar codes at collection can be consigned to other company.

(4) In the embodiment, the shipping information and the collection time information is stored in the shipping data storing section 14 relating to the bar code number 21 and managed by the management computer 11. Therefore, the management of the system is easy and the collection time information is easily obtained.

(5) In the embodiment, the bar code number 21 of the bar code 30B, 31B that is put on the toner cartridge 30 and the box 31 may be same as the bar code number 21 of the toner cartridge 30 that has been shipped and collected. Therefore, the bar code number 21 is necessary to have a predetermined range of numbers and the width of the bar code 30B, 31B is not necessary to be made larger.

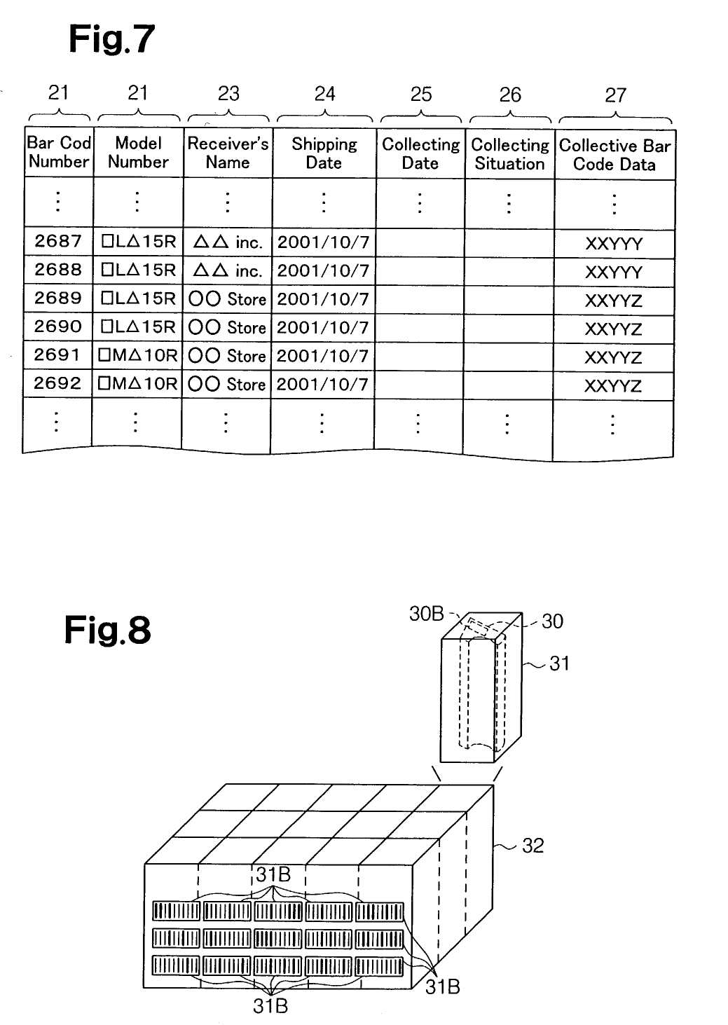

Next, a system for managing expendable supplies according to a second embodiment will be explained with reference to FIGS. 6 and 7. In each following embodiment, the same numerals are applied to the same portion as in the above embodiment and the detailed explanation thereof is omitted.

In the second embodiment, a plurality of boxes 31 (fifteen in FIG. 6) accommodating the toner cartridges 30 are accommodated in a collective box 32 as collective package. A collective bar code 32B that is similar to the bar code 30B is put on a side wall of the collective box 32. The collective bar code 32B has an collective bar code number 27 that is unique to the collective box 32. The bar code numbers 21 of the bar code 31B, 30B on the box 31 accommodated in the collective box 32 and the toner cartridge 30 are related to the collective bar code number 27. When the box 31 is accommodated in the collective box 32, the bar code number 21 of the bar code 31B on the box 31 is related to the collective bar code number 27 of the collective bar code 32B on the collective box 32 and the bar code number 21 and the collective bar code number 27 are stored in the process computer 12.

In the second embodiment, each of the bar code numbers 21 of the bar codes 30B put on the toner cartridges 30 that are accommodated in the same collective box 32 is different from each other. Similarly to the above embodiment, the bar code 31B having the bar code number 21 the same as the bar code number 21 of the bar code 30B put on the accommodated toner cartridge 30 is put on the box 31 accommodating the toner cartridge 30. Therefore, in the second embodiment, each of the bar code numbers 21 of the bar codes 31B on the boxes 31 accommodated in the same collective box 32 is different from each other.

In the second embodiment, when the collective bar code number 27 of the collective bar code 32B is read at shipping, the model number 22, the receiver's name 23 and the shipping date 24 are temporally stored in the process computer 12 relating to the bar code number 21 that is related to the collective bar code number 27. The process computer 12 sends the bar code number 21, the model number 22, the receiver's name 23, the shipping date 24 and the collective bar code number 27 to the management computer 11. The management computer 11 stores the information in the process computer 12. As shown in FIG. 7, the boxes 31 having the bar code numbers 21 having the same collective bar code number 27 are accommodated in the same collective box 32 and shipped to the same receiver's name 23 on the shipping date 24.

When the toner cartridges 30 are collected by the collecting center RC, the same process is executed as the first embodiment to obtain the collection rate and the collection period.

Therefore, according to the second embodiment, the following advantages are obtained in addition to the advantages of (2)-(5) according to the first embodiment.

(6) In the second embodiment, the collective bar code 32B corresponding to the bar code number 21 of the bar code 30B on each toner cartridge 30 that is accommodated in the collective box 32 is put on the collective box 32 that accommodates a plurality of toner cartridges 30. Therefore, even if the toner cartridges 30 are accommodated in the collective box 32, the shipping information is stored at shipping with relating to the bar code numbers 21 of the toner cartridges 30 that are to be shipped without taking out the toner cartridges 30 from the collective box 32. Therefore, all the bar code numbers 21 of the toner cartridges 30 can be obtained without taking time or labor.

Next, a system for managing expendable supplies according to a third embodiment will be explained with reference to FIG. 8.

As shown in FIG. 8, in the third embodiment, the bar code 31B is not put on the box 31 that accommodates the toner cartridge 30. Instead, the bar codes 31B that should be put on the boxes 31 are put on a side wall of the collective box 32 that accommodates the boxes 31. The bar codes 31B are put on the side wall of the collective box 32 in alignment with each other corresponding to a position of each box 31 that is accommodated in the collective box 32.

In the third embodiment, each of the bar codes 30B of the toner cartridges (in the box 31) accommodated in the collective box 32 has a different bar code number 21. The bar code 31B has the same bar code number 21 as the bar code number 21 of the bar code 30B on each toner cartridge 30. Therefore, each of the bar codes 31B put on the collective box 32 has a different bar code number 21.

Therefore, when the collective box 32 is shipped, all the bar codes 31B on the collective box 32 are read by the bar code reading terminal 17 to obtain data as shown in FIG. 7 and the shipping process the same as the second embodiment is executed.

Therefore, in the third embodiment, the following advantages can be obtained in addition to the advantages of (2)-(5).

(7) In the third embodiment, the bar code 31B having the same bar code number 21 as the bar code 30B that is put on the toner cartridge 30 accommodated in the collective box 32 is put on the collective box 32 that accommodates a plurality of toner cartridges 30. Therefore, when the bar code 31B put on the collective box 32 is read, the bar code numbers 21 of the toner cartridges 30 that are shipped are read at once without taking out the toner cartridges from the collective box 32 even if the toner cartridges 30 are accommodated in the collective box 32. All the bar code numbers 21 of the toner cartridges 30 can be obtained without taking time or labor.

(8) In the third embodiment, the bar codes 31B that should be put on the boxes 31 are put on the collective box 32. Therefore, the operation for sticking the bar codes 31B to the boxes 31 is omitted and the labor is reduced.

It should be apparent to those skilled in the art that the present invention may be embodied in many other specific forms without departing from the spirit or scope of the invention. Particularly, it should be understood that the invention may be embodied in the following forms.

In the above embodiments, the one-dimensional bar code is used as the identifier, however, a two-dimensional bar code or an IC chip may be used as the identifier. The bar code number 21 is used as the identifier, however, characters, numerals or the combination thereof may be used as the identifier.

In the above embodiments, when the toner cartridge 30 accommodated in the box 31 is shipped, the bar code 31B having the same number as the bar code number 21 of the bar code 30B is put on the box 31 so that the bar code 30B of the toner cartridge 30 is read. Instead, a part of the box 31 may be formed of a transparent material so that the bar code 30B of the toner cartridge 30 is positioned corresponding to the transparent portion. The bar code reading terminal 17 reads the bar code 30B of the toner cartridge 30 in a condition that the toner cartridge 30 is accommodated in the box 31.

In the above embodiments, the bar code numbers 21 of the collected toner cartridges 30 are read at the collecting center RC. However, the bar codes of the toner cartridges 30 may be read at each recycling company RH1, RH2 and the read information may be sent to the management computer 11 at the headquarters H.

The above embodiments are explained about the toner cartridge 30 as the expendable supplies. However, the expendable supplies may be other expendable supplies that can be collected and recycled, for example, an ink cartridge, a core of a rolled paper, an ink ribbon or package.

Therefore, the present examples and embodiments are to be considered as illustrative and not restrictive and the invention is not to be limited to the details given herein, but may be modified within the scope and equivalence of the appended claims.

What is claimed is:

1. Expendable supplies, which are collectable and recyclable, wherein each expendable supply has one of different identifiers and the identifier of each expendable supply is the same as an identifier given to a package that packages the expendable supply.

2. The expendable supplies according to claim 1, wherein each identifier is represented by a bar code.

3. Packages for packaging expendable supplies, the expendable supplies being collectable and recyclable, wherein one of different identifiers is given to each expendable supply, wherein an identifier is given to each package, and wherein the identifier of each package is the same as the identifier given to the corresponding expendable supply.

4. Packages according to claim 3, wherein each identifier is represented by a bar code.

5. Packages according to claims 3, wherein each of said packages accommodates a plurality of expendable supplies, and wherein said package includes a collective identifier containing information relating to the identifier of each expendable supply.

6. A collective package for collectively packaging a plurality of expendable supplies, the expendable supplies being collectable and recyclable, wherein each expendable supply has one of different identifiers, wherein the identifier of each expendable supply is the same as an identifier given to a package that packages the expendable supply, and wherein the collective package has a collective identifier, the collective identifier including the information of the identifiers of the expendable supplies.

7. A collective packages according to claim 6, wherein each identifier is represented by a bar code.

8. A system for managing shipping and collecting of expendable supplies, each expendable supply having one of different identifiers, the identifier of each expendable supply being the same as an identifier given to a package that packages the expendable supply, the system comprising:
first recording means for recording shipment information of each expendable supply in association with the identifier of the corresponding package, wherein the identifiers of the packages are read at shipping;
second recording means recording collection time information of each expendable supply in association with the identifier of the supply, wherein the identifiers of the expendable supplies are read when the supplies are collected; and
collection information generating means, which computes collection information including a collection rate and a collection period based on the shipment information and the collection time information respectively recorded by the first recording means and the second recording means.

9. A system according to claim 8, wherein each identifier is represented by a bar code.

10. A system according to claims 8, wherein each of said packages accommodates a plurality of expendable supplies, and wherein said package includes a collective identifier containing information relating to the identifier of each expendable supply.

11. A system for managing expendable supplies, comprising:
first reading means for reading identifiers given to packages of the expendable supplies at shipping;
first recording means for recording shipment information in association with the identifiers read by the first reading means;
second reading means for reading the identifiers given to the collected expendable supplies or the identifiers given to the collected packages;
second recording means for recording collection time information based on the identifiers read by the second reading means; and
generating means for computing collection information including a collection rate and a collection period based on the shipment information and the collection time information.

12. A system according to claim 11, wherein each identifier is represented by a bar code.

13. A system according to claims 11, wherein each of the packages accommodates a plurality of expendable supplies, and wherein the package includes a collective identifier containing information relating to the identifier of each expendable supply.

14. A method for managing expendable supplies, wherein one of different identifiers is given to each expendable supply, wherein the identifier of each expendable supply is the same as an identifier given to a package that packages the expendable supply, the method comprising steps of:
reading the identifiers of the packages;
recording shipment information in association with the read identifiers;
reading the identifiers of the collected expendable supplies;
recording collection time information in association with the identifiers; and
obtaining collection information including a collection rate and a collection period based on the shipment information and the collection time information.

15. A method according to claim 14, wherein each identifier is represented by a bar code.

16. A method according to claims 14, wherein each of said packages accommodates a plurality of different expendable supplies, and wherein said package includes a collective identifier containing information relating to the identifier of each expendable supply.
